(19) United States
(12) Patent Application Publication
(10) Pub. No.: US 2010/0061311 A1
(43) Pub. Date: Mar. 11, 2010

(54) Opportunistic Uplink Feedback Scheme for MU-MIMO Systems

(75) Inventors: Shu-Shaw Wang, Arlington, TX (US); Kyeongjin Kim, Irving, TX (US); Shaohua Li, Beijing (CN); Xin Qi, Beijing (CN)

Correspondence Address: BRAKE HUGHES BELLERMANN LLP, c/o CPA Global, P.O. BOX 52050, MINNEAPOLIS, MN, 55402, US

(73) Assignee: Nokia Siemens Networks Oy, Espoo (FI)

(21) Appl. No.: 12/205,663

(22) Filed: Sep. 5, 2008

(51) Int. Cl. H04W 28/16

(52) U.S. Cl. 370/329

(57) ABSTRACT

According to one general aspect, a method of using a base station comprising establishing an association between the base station and at least one mobile station (MS) via a communications channel. In such an embodiment, the communications channel may be divided into resource blocks. In various embodiments, the method may include broadcasting a signal-to-noise (SNR) threshold message that includes a SNR threshold. In some embodiments, the method may include receiving at least one reporting message, respectively from the at least one mobile station(s), indicating which resource blocks measured a SNR equal to or above the SNR threshold. In various embodiments, the method may also include allocating, in a time division multiplexing mode, resource blocks for communication with the mobile station(s) based, at least in part, upon the reporting message(s).

### TECHNICAL FIELD

This description relates to communications, and more specifically to the feedback of communication channel condition information and the allocation of resources based, in part, upon the information feedback.

### BACKGROUND

Worldwide Interoperability for Microwave Access (WiMAX) is a telecommunications technology often aimed at providing wireless data over long distances (e.g., kilometers) in a variety of ways, from point-to-point links to full mobile cellular type access. A network based upon WiMAX is occasionally also called a Wireless Metropolitan Access Network (WirelessMAN or WMAN); although, it is understood that WMANs may include protocols other than WiMAX. WiMAX often includes a network that is substantially in compliance with the IEEE 802.16 standards, their derivatives, or predecessors (hereafter, “the 802.16 standard”). Institute of Electrical and Electronics Engineers, IEEE Standard for Local and Metropolitan Area Networks, Part 16, IEEE Std. 802.16-2004.

One particular derivative of the 802.16 standard is the, as yet finished, 802.16m standard that attempts to increase the data rate of wireless transmissions to 1 Gbps while maintaining backwards compatibility with older networks. IEEE 802.16 Broadband Wireless Access Working Group, IEEE 802.16m System Requirements, Oct. 19, 2007.

Wireless Local Area Network (WLAN) is a telecommunications technology often aimed at providing wireless data over shorter distances (e.g., meters or tens of meters) in a variety of ways, from point-to-point links to full mobile cellular type access. A network based upon the WLAN standard is occasionally also referred to by the common or marketing name “WiFi” (or “Wi-Fi”) from Wireless Fidelity; although it is understood that WLAN may include other shorter ranged technologies. WiFi often includes a network that is substantially in compliance with the IEEE 802.11 standards, their derivatives, or predecessors (hereafter, “the 802.11 standard”). Institute of Electrical and Electronics Engineers, IEEE Standard for Information Technology—Telecommunications and Information Exchange between Systems—Local and Metropolitan Area Network—Specific Requirements—Part 11: Wireless LAN Medium Access Control (MAC) and Physical Layer (PHY) Specifications, IEEE Std. 802.11-2007.

Multiple-input and multiple-output (MIMO), is generally the use of multiple antennas at both a transmitter and a receiver to improve communication performance. It is often considered one of several forms of smart antenna technology. MIMO technology frequently offers significant increases, compared to single input/output technology, in data throughput and link range without additional bandwidth or transmit power. MIMO systems generally achieve this by higher spectral efficiency (e.g., more bits per second per hertz of bandwidth) and link reliability or diversity (e.g., reduced fading). In general, Close Loop (CL) multi-user (MU) MIMO systems require feedback of communications channel information from all the active users. The feedback overhead however, often decreases the efficiency of the MU-MIMO system capacity.

A frequent cellular network implementation may have multiple antennas at a base station (BS) and a single antenna on the mobile station (MS). In such an embodiment, the cost of the mobile radio may be minimized. As the costs for radio frequency (RF) components in mobile station are reduced, second antennas in mobile device may become more common. Multiple mobile device antennas may currently be used in Wi-Fi technology (e.g., IEEE 802.11n).

### SUMMARY

According to one general aspect, a method of using a base station comprising establishing an association between the base station and at least one mobile station (MS) via a communications channel. In such an embodiment, the communications channel may be divided into resource blocks. In various embodiments, the method may include broadcasting a signal-to-noise (SNR) threshold message that includes a SNR threshold. In some embodiments, the method may include receiving at least one reporting message, respectively from the at least one mobile station(s), indicating which resource blocks measured a SNR equal to or above the SNR threshold. In various embodiments, the method may also include allocating, in a time division multiplexing mode, resource blocks for communication with the mobile station(s) based, at least in part, upon the reporting message(s).

According to another general aspect, a method of using a mobile station comprising establishing an association between the mobile station and a base station via a communications channel. In various embodiments, the communications channel may be divided into resource blocks. In some embodiments, the method may include receiving, from the base station, a broadcast signal-to-noise (SNR) threshold message including a SNR threshold value. In various embodiments, the method may include measuring a SNR for each resource block of the received SNR threshold message. In one embodiment, the method may also include, if at least one resource block includes a SNR equal to or above the SNR threshold value, transmitting a reporting message, to the base station, indicating which resource block(s) include a SNR equal to or above the SNR threshold value.

According to another general aspect, an apparatus comprising a transceiver, a controller, and a memory. In some embodiments, the a transceiver may be configured to establish an association between the apparatus and at least one mobile station (MS) via a communications channel, wherein the communications channel is divided into resource bands. In some embodiments, the transceiver may be configured establish an association between the apparatus and at least one mobile station (MS) via a communications channel, wherein the communications channel is divided into resource bands. In some embodiments, the transceiver may be configured to broadcast a signal-to-noise (SNR) threshold message that includes a SNR threshold. In various embodiments, the transceiver may be configured to receive at least one reporting message, from at least one of the mobile stations, indicating which resource bands the respective mobile station(s) measured a SNR equal to or above the SNR threshold. In various embodiments, the memory may be configured to store at least a portion of the information included in received reporting message(s). In one embodiment, the controller may be configured to allocate resource blocks for communication with the mobile station(s) based, at least in part, upon the received reporting message(s).

According to another general aspect, an apparatus comprising a transceiver, and a controller. In various embodiments, the transceiver may be configured to establish an association between the apparatus and a base station (BS) via a communications channel, wherein the communications channel is divided into resource bands. In some embodiments, the transceiver may also be configured to establish an association between the apparatus and a base station (BS) via a communications channel, wherein the communications channel is divided into resource bands. In some embodiments, the transceiver may be configured to receive, from the base station, a signal-to-noise (SNR) threshold message including a SNR threshold value. In various embodiments, the transceiver may also be configured to, if at least one resource band includes a SNR equal to or above the SNR threshold value, transmit a reporting message, to the base station, indicating which resource bands include a SNR equal to or above the SNR threshold value. In various embodiments, the controller may be configured to measure channel state information for each resource band of the communications channel.

The details of one or more implementations are set forth in the accompanying drawings and the description below. Other features will be apparent from the description and drawings, and from the claims.

A system and/or method for communicating information, substantially as shown in and/or described in connection with at least one of the figures, as set forth more completely in the claims.

### BRIEF DESCRIPTION OF THE DRAWINGS

FIG. 1 is a block diagram of an example embodiment of a system in accordance with the disclosed subject matter.

FIG. 2 is a block diagram of a example embodiments of an apparatus in accordance with the disclosed subject matter.

FIG. 3 is a block diagram of an example embodiment of a series of frames in accordance with the disclosed subject matter.

FIG. 4 is a block diagram of an example embodiment of a system in accordance with the disclosed subject matter.

FIG. 5 is a block diagram of an example embodiment of a system in accordance with the disclosed subject matter.

FIG. 6 is a table of an example embodiment of a coding scheme of system in accordance with the disclosed subject matter.

FIG. 7 is a flow chart of an example embodiment of a technique in accordance with the disclosed subject matter.

FIG. 8 is a flow chart of an example embodiment of a technique in accordance with the disclosed subject matter.

### DETAILED DESCRIPTION

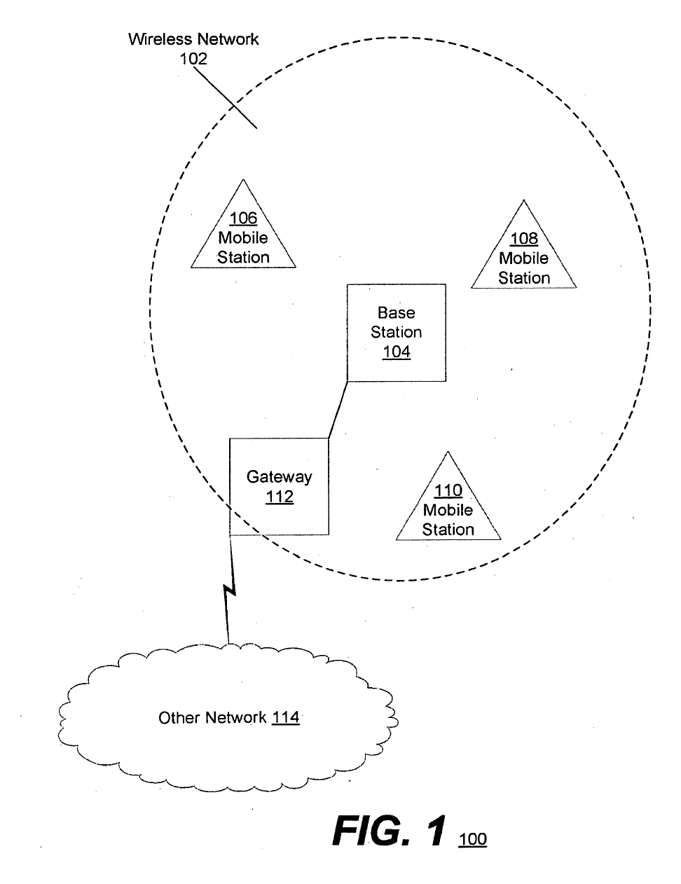

Referring to the Figures in which like numerals indicate like elements, FIG. 1 is a block diagram of a wireless network 102 including a base station (BS) 104 and mobile stations (MSs) 106, 108, 110, according to an example embodiment. Each of the MSs 106, 108, 110 may be associated with BS 104, and may transmit data in an uplink direction to BS 104, and may receive data in a downlink direction from BS 104, for example. Although only one BS 104 and three mobile stations (MSs 106, 108 and 110) are shown, any number of base stations and mobile stations may be provided in network 102. Also, although not shown, mobile stations 106, 108 and 110 may be coupled to base station 104 via relay stations or relay nodes, for example. The base station 104 may be connected via wired or wireless links to another network (not shown), such as a Local Area Network, a Wide Area Network (WAN), the Internet, etc. In various embodiments, the base station 104 may be coupled or connected with the other network 120 via an access network controller (ASN) or gateway (GW) 112 that may control, monitor, or limit access to the other network.

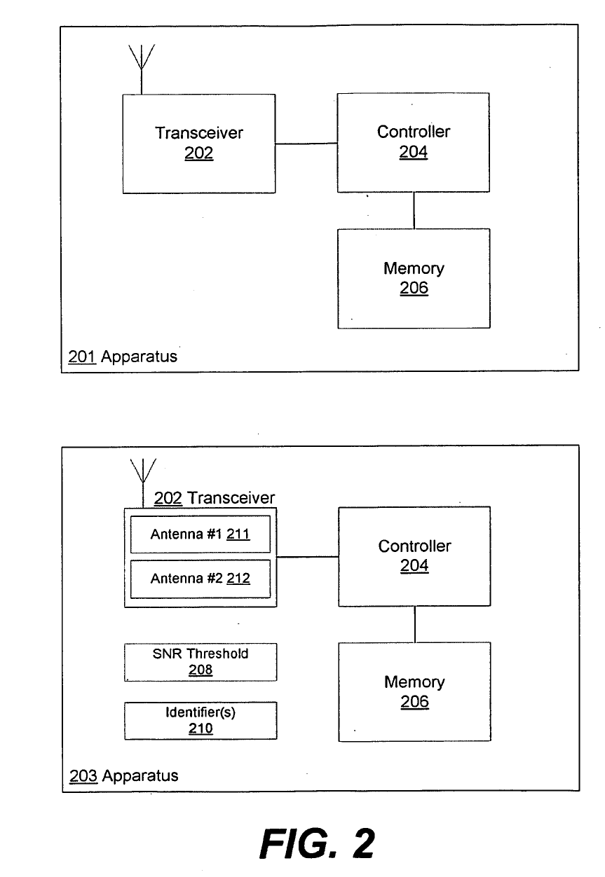

FIG. 2 is a block diagram of two example embodiments of apparatuses 201 and 203 in accordance with the disclosed subject matter. In one embodiment, the communications device 201 may include a base station (BS) or a mobile station (MS) such as that illustrated in FIG. 1. In one embodiment, the communications device 201 may include a transceiver 202, a controller 204, and a memory 206. In some embodiments, the transceiver 202 may include a wireless transceiver configured to operate based upon a wireless networking standard (e.g., WiMAX, WiFi, WLAN, etc.). In other embodiments, the transceiver 202 may include a wired transceiver configured to operate based upon a wired networking standard (e.g., Ethernet, etc.). In various embodiments, the controller 204 may include a processor. In various embodiments, the memory 206 may include permanent (e.g., compact disc, etc.), semi-permanent (e.g., a hard drive, etc.), and/or temporary (e.g., volatile random access memory, etc.) memory. For example, some operations illustrated and/or described herein, may be performed by a controller 204, under control of software, firmware, or a combination thereof. In another example, some components illustrated and/or described herein, may be stored in memory 206.

FIG. 2 is also a block diagram of a communications device 203 in accordance with an example embodiment of the disclosed subject matter. In one embodiment, the communications device 203 may include a base station (BS) or a mobile station (MS) such as that illustrated in FIG. 1. In one embodiment, the communications device 203 may include a wireless transceiver 202, a controller 204, and a memory 206. In some embodiments, the transceiver 202 may include a wireless transceiver configured to operate based upon a wireless networking standard (e.g., WiMAX, WiFi, WLAN, etc.). In other embodiments, the transceiver 202 may include a wired transceiver configured to operate based upon a wired networking standard (e.g., Ethernet, etc.). In various embodiments, the controller 204 may include a processor. In various embodiments, the transceiver 202 may include a plurality of antennas, such as antenna #1 211 and antenna #2 212. In one embodiment, the communications device 203 may include a threshold or signal-to-noise (SNR) threshold 208. In various embodiments, the SNR threshold 208 may be stored by the memory 206. In some embodiments, the communications device 203 may include at least one identifier 210 configured to substantially uniquely identify each antenna (e.g., antennas 211 and 212). In various embodiments, the identifier 210 may be stored by the memory 206.

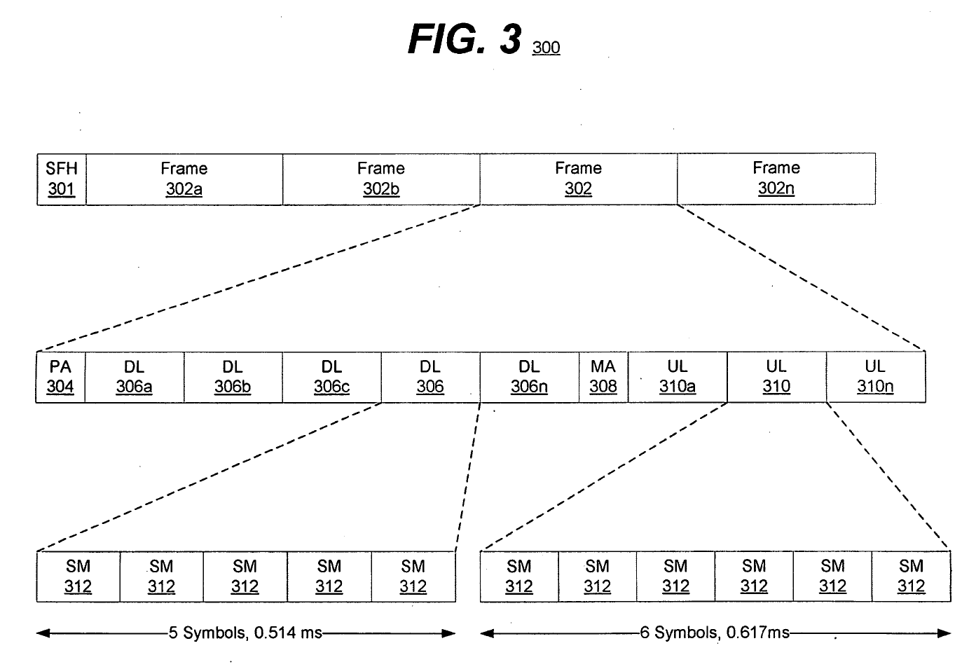

FIG. 3 is a block diagram of an example embodiment of a series of frames in accordance with the disclosed subject matter. In one embodiment, the base station and various mobile stations may communicate with each other using a series or plurality of frames or super-frame 300.

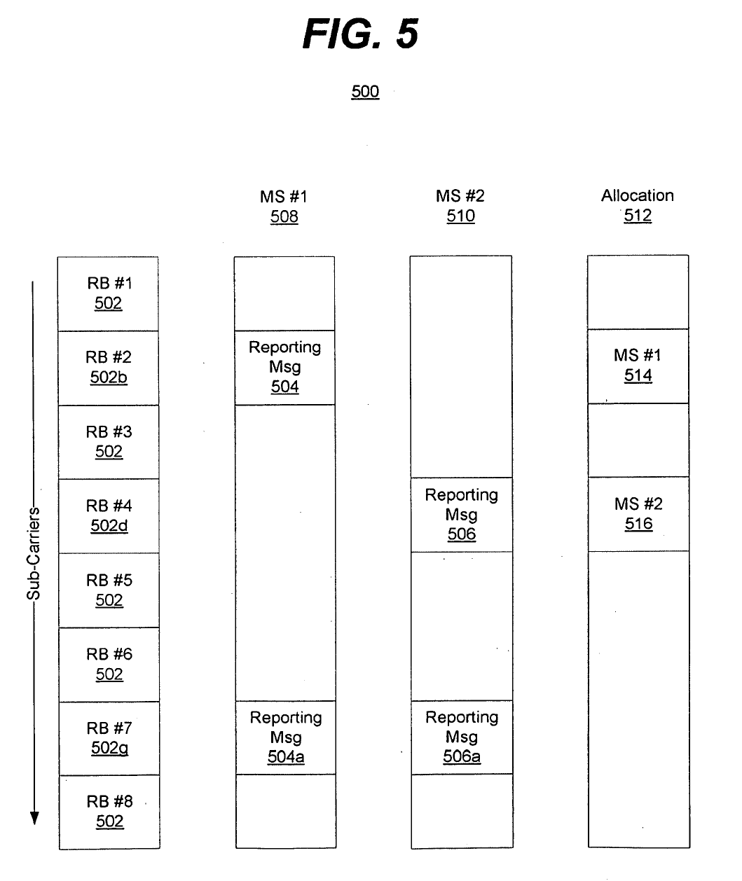

These frames may be transmitted over or via a communications channel. The following provides an overall context of the communications channel. In this context, a communications channel may include a medium used to convey information from a sender to a receiver. FIG. 3 illustrates the division of the communications channel as a function of time (e.g., time division multiplexing). In addition, a communications channel may also be divided as a function of frequency, illustrated more completely in FIG. 5. In various embodiments, this communications channel may include a plurality of frequencies or a bandwidth of frequencies. This bandwidth may be sub-divided into sub-channels or sub-carriers. Each of these sub-carriers may include their own respective bandwidth. In various embodiments, these sub-carriers may generally be of equal size.

In various embodiments, the communications channel may be divided by both time and frequency into resource blocks. In such an embodiment, a resource block may include a given sub-channel or sub-channels for a period of time. These resource blocks may provide the fundamental blocks of communication. In this context, a resource band may be the frequency and time based component of a resource block and include the sub-channels comprising a resource block.

A controlling device (e.g., a base station), in one embodiment, may allocate resource blocks amongst mobile devices. In such an embodiment, the base station may attempt to perform this allocation in such a way as to reduce the number of un-received or un-usable (e.g., garbled, noise ridden, etc.) transmissions. In various embodiments, it may not be possible to make use of every possible resource block or resource band.

FIG. 3 illustrates a plurality of frames. In various embodiments, the plurality of frames may be organized into a super-frame 300. In one embodiment, this super-frame 300 may include a super-frame header 301 and frames 302a, 302b, 302, and 302n. Frame 302 may include a down-link (DL) portion and an uplink (UL) portion. In various embodiments, a DL sub-frame 306 may be reserved for communication from the base station to a mobile station. Conversely, an UL sub-frame 310 may be reserved for communication from the mobile station to the base station.

In one embodiment, a frame 302 may include a pre-amble 304, a plurality of DL sub-frames (e.g., DL sub-frames 306a, 306b, 306c, 306, and 306n), a mid-amble 308, and a plurality of UL sub-frames (e.g., UL sub-frames 310a, 310, and 310n). In various embodiments, the mid-amble 308 and pre-amble 304 may, respectively, delineate the transition between the DL and UL portions of the frame 302 and between frames themselves. In one embodiment, the pre-amble 304 and mid-amble 308 may include a signal that is broadcast to any listening devices within the range of the base station or other transmitting device.

Conversely, a DL sub-frame 306 or UL sub-frame 310 may include messages generally intended for a specific receiver or group of receivers. Occasionally these sub-frames may be used to broadcast information (e.g., resource allocation, channel condition feedback, etc.). These time based sub-frames may be, in one embodiment, additionally divided by frequency into the resource blocks (not shown) which are allocated to mobile stations to either receive or send information. In such an embodiment, the sub-frame may be the practical time division of the communications channel.

In various embodiments, the DL sub-frame 306 may include a plurality of symbols 312. In one specific embodiment, the DL sub-frame 306 may include five symbols 312 and duration of approximately 0.514 ms. In various embodiments, the UL sub-frame 310 may include a plurality of symbols 312. In one specific embodiment, the UL sub-frame 310 may include six symbols 312 and duration of approximately 0.617 ms. In various embodiments, these symbols 312 are orthogonal frequency-division multiple access (OFDMA) symbols. In one embodiment, an UL resource block may include a resource band or bandwidth of 18 sub-carriers, and a time duration or length of six symbols 312. In various embodiments, a resource block size may be configurable or predefined. It is understood that the above are merely a few illustrative examples to which the disclosed subject matter is not limited.

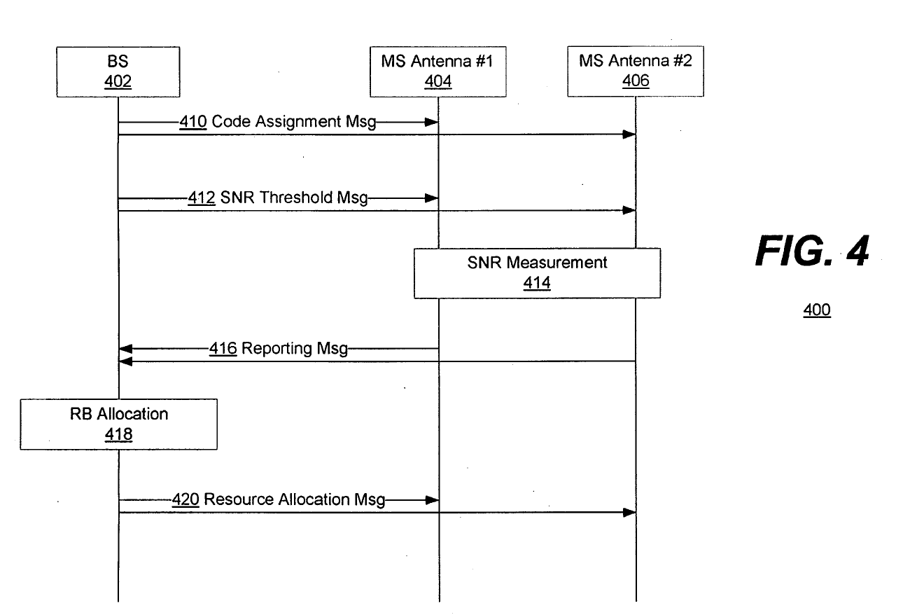

FIG. 4 is a block diagram of an example embodiment of a system 400 in accordance with the disclosed subject matter. In one embodiment, the system 400 may include a BS 402, and a mobile station. In various embodiments, the mobile station may include a first antenna 404 and a second antenna 406. However, it is understood that the disclosed subject matter is not limited to a fixed number of antennas and that FIG. 4 is merely an illustrative embodiment.

In one embodiment, the BS 402 may establish an association or a connection with at least one mobile station, as described above. In various embodiments, this establishment may include broadcasting a message identifying the BS 402, receiving a message from the MS requesting an association, and authenticating the MS; although, it is understood that the above is merely one illustrative example to which the disclosed subject matter is not limited.

In one embodiment, the BS 402 may broadcast or individually transmit a code assignment message 410 to a MS or each MS antenna 404 and 406. In various embodiments, this code assignment message 410 may include an assignment of a substantially unique identifier or code to each antenna (e.g., MS antennas 404 and 406). In such an embodiment, this code may be used to identify from which antenna a message (e.g., reporting message 416) originates, as described below. In various embodiments, a resource block may not be large enough to allow for uniquely identifying all associated antennas. In such an embodiment, the BS 402 may re-assign mostly unique identifiers to each antenna (including any new antennas) or, in one embodiment, the BS 402 may simply accept that the origin of some messages (e.g., reporting message 416) may be indeterminate and assign identifiers in such a way as to minimize or manage that possibility.

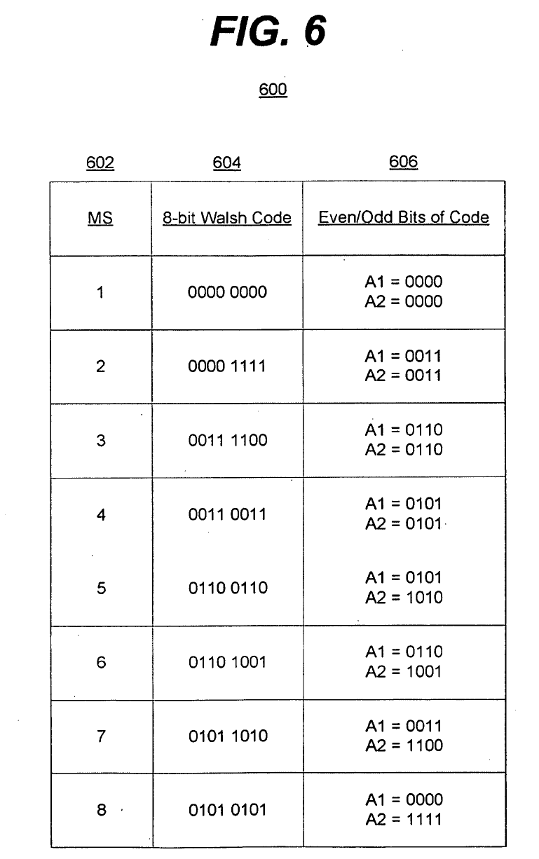

In various embodiments, the code assignment message 410 may include a specific message. In another embodiment, the code assignment message 410 may be included as part of another message (e.g., a MS attachment response message, etc.). In such an embodiment, the code assignment message 410 may include a parameter or element of the other or carrier message. In one such embodiment, the code assignment message 410 may be or include a type-length-value (TLV) element that specifics that it is a parameter or element including the code assignment and a value for the code or codes assignment. A specific embodiment of a substantially uniquely identifiable code assignment is discussed below in reference to FIG. 6. Although, it is understood that the above are merely a few illustrative examples to which the disclosed subject matter is not limited.

In one embodiment, the BS 402 may transmit or broadcast a signal-to-noise ratio (SNR) threshold message 412 to at least one mobile station actively associated with the base station. In various embodiments, a MS may temporarily go inactive or otherwise leave the network including the BS. In various embodiments, these MSs may not receive the SNR threshold message 412. In various embodiments, the BS 402 may broadcast this SNR threshold message 412, as described above in reference to the code assignment message 410.

In this context, a SNR is defined as the ratio of an average signal power to the noise power corrupting the signal. In various embodiments, a signal-to-noise ratio compares the strength of a desired signal (e.g., data communication) to the strength of background noise. In general, the higher the ratio, the less obtrusive the background noise is and, therefore, the more likely it is that information (i.e., the signal) may be transmitted without errors.

In one embodiment, the BS 402 may determine a threshold SNR below which the BS 402 has determined that communication is not worthwhile or desirable. In various embodiments, this threshold level may be predetermined. In another embodiment, this SNR threshold level may be configurable (e.g., via a network administration server, during BS 402 provisioning configuration, etc.). In yet another embodiment, this SNR threshold may be dynamically adjustable. In one embodiment, the BS 402 may not receive an acceptable response from the MSs, as described below. In such an embodiment, the BS 402 may lower the SNR threshold until a minimum value is reached or the BS 402 is satisfied with the MSs' responses. In various embodiments, the definition of what level of response the BS 402 considers acceptable may be predefined, configurable, dynamically adjustable or a combination thereof In various embodiments, this level of acceptability may be in terms of quantity of response or in terms of final allocation options, as described below.

Block 414 illustrates that, in one embodiment, upon receipt of the broadcast SNR threshold message 412, the MSs or their antennas (e.g., MS antennas 404 and 406) may measure the SNR of some or all of the sub-carriers or resource bands of the communications channel. In various embodiments, measuring the SNR of some or all of the sub-carriers may include measuring the SNR of the resource block or resource band used to transmit the broadcast SNR threshold message 412. In some embodiments, the SNR may be measured for each antenna (e.g., MS antennas 404 and 406). In another embodiment, the SNR may be measured at one antenna or an average of all antennas may be computed for the MS.

In various embodiments, the MS or each antenna of the MS (e.g., MS antennas 404 and 406) may respond to the SNR threshold message 412 with a reporting message 416. In one embodiment, the reporting message 416 may consume or occur not just during a specifically allocated resource block, but on an entire UL OFDMA symbol. In one such embodiment, not just one MS, but all MSs associated with the BS 402, or all the antennas of the MSs associated with the BS 402 may substantially simultaneously transmit their respective reporting messages 416. This is contrasted with what, in one embodiment, is “normal” communication in which a MS (or its antennas) is allocated specific resource blocks and communication only occurs on those resource blocks to avoid interference from other MSs.

In one embodiment, to minimize such interference, a MS or the MSs individual antennas may only transmit their reporting message 416 using a sub-carrier, resource black, or resource block whose SNR was equal to or above the SNR threshold as established by the BS 402 in the SNR threshold message 412. This is described below and illustrated in FIG. 5. It is contemplated that various MSs, as mobile devices, may be at different locations and therefore experience different SNRs. In one embodiment, if the reporting message 416 is transmitted only using the sub-carriers or resource bands experiencing an SNR equal to or above the SNR threshold, the probability of inter-MS interference within any one resource block or resource band may be reduced.

In one embodiment, the MS or the MS antennas (e.g., MS antennas 404 and 406) may only transmit a maximum number of reporting messages 416 or, said another way, transmit the reporting message 416 via a maximum number of resource blocks or resource bands. In some embodiments, only the resource blocks or resource bands with the highest SNR may be used to satisfy this maximum limit. In various embodiments, the maximum number of resource blocks or resource bands used may be predefined (e.g., via a networking standard used by the system 400). In another embodiment, the maximum number of resource blocks or resource bands used or reported may be dynamically set by the BS 402. In one embodiment, this may occur via messages such as, the code assignment message 410, the SNR threshold message 412, etc. Also, in one embodiment, the maximum number of reporting resource blocks or resource bands may be set similarly to that which is described above in reference to other messages. In various embodiments, the BS 402 may alter this number as a function of communication channel conditions, number of MSs associated with the BS 402, etc.; although, it is understood that the above are merely a few illustrative examples to which the disclosed subject matter is not limited.

In a different embodiment, the BS 402 may request that a number (e.g., five) of reporting messages 416 be sent regardless of the SNR threshold. In such an embodiment, the SNR of each resource block or resource bands may be measured and the resource blocks or resource bands with the highest SNR may be used for the reporting message 416. In such an embodiment, the SNR threshold may be considered zero, with a set limit or maximum number of reporting messages 416 returned.

In various embodiments, the reporting message 416 may include only the assigned code or identifier from the code assignment message 410. In such an embodiment, only two pieces of information may be conveyed by the reporting message 416: which resource block or resource band is above the SNR threshold and which MS (or MS antenna) considers the resource block or resource band above the SNR threshold. In various embodiments, other message formats may be used to convey additional or different information.

In such an embodiment, the BS 402 may receive a plurality of reporting messages 416 via a plurality of resource blocks. In various embodiments, the BS 402 may determine which resource blocks or resource bands experience a sufficient (as defined by the SNR threshold) SNR and are therefore considered “good”, and from which MS or MS antenna (e.g., MS antennas 404 and 406) the reporting message 416 delivered via each “good” resource block originated. In various embodiments, these “good” resource blocks or resource bands may be considered allocate-able to the MSs who transmitted the reporting messages 416 via them.

In some embodiments, multiple MSs may transmit a reporting message 416 via the same resource block or resource band. In such an embodiment, the BS 402 may be able to determine that a resource block or resource band is “good”, but not which MS transmitted the reporting message 416 (e.g., due to inter-symbol interference, non-unique code assignments, etc.). In various embodiments, the BS 402 may mark the resource block or resource band as “bad” or “not good” and attempt to not use the resource block for allocation purposes.

In various embodiments, the broadcasting of the SNR threshold message 412 may occur as part of a broadcast message directly before the UL sub-frames of a frame (e.g., a mid-amble). In such an embodiment, the first UL sub-frame may be used or reserved for the transmission of the expected reporting messages 416. In such an embodiment, the latency between the SNR threshold message 412 and the reporting messages 416 may be reduced. Although, it is understood that the above is merely one illustrative example to which the disclosed subject matter is not limited.

Block 418 illustrates that, in one embodiment, the BS 402 may perform resource block (RB) allocation based in part upon the received reporting message 416. In various embodiments, this RB allocation 418 may include RB allocation for MSs during both a DL sub-frame portion and an UL sub-frame portion. In various embodiments, a RB allocation message 420 may occur during the normal resource block allocation of the next or subsequent frame.

In various embodiments, the BS 402 may transmit a SNR threshold message 412 opportunistically. In another embodiment, the BS 402 may transmit a SNR threshold message 412 periodically or, in one embodiment, as part of every frame. In various embodiments in which the SNR threshold message 412 is transmitted opportunistically, the BS 402 may monitor or accumulate data regarding the communications channel conditions (e.g., number of resend requests, number of MSs, SNR experienced by the BS 402, etc.). In such an embodiment, the BS 402 may broadcast a SNR threshold message 412 when it is determined that the communications channel condition has fallen below an acceptable standard or threshold. In various embodiments, this standard or threshold may be predetermined, configurable, or dynamically adjustable, etc. In various embodiments, this standard or threshold may be a relative (versus absolute) standard (e.g., a rate of change of the communications channel's condition, etc.).

In various embodiments, the opportunistic unsolicited transmission of the SNR threshold message 412 may reduce the overall overhead of MIMO feedback (e.g., as compared to non-opportunistic schemes). In some embodiments, the periodic or opportunistic unsolicited transmission of the SNR threshold message 412 may reduce the power requirements or drain experienced by the MSs (e.g., due to the reduced transmission of the reporting message 416). In yet another embodiment, reallocation of resource blocks based upon the reported SNR may reduce the need for MSs with lower SNRs to transmit information using higher power levels, due to specifically selected RBs versus randomly or non-SNR aware selected RB allocation).

FIG. 5 is a block diagram of an example embodiment of a system 500 in accordance with the disclosed subject matter. As opposed to FIG. 3 which is oriented by time, FIG. 5 is oriented by frequency and shows a plurality of resource blocks (RBs) or resource bands 502 as a function of sub-carriers. In this context, a resource band may be a resource block without a defined time component. Colloquially, the term “resource block” may be used when referring to a “resource band”. FIG. 5 illustrates one embodiment of reporting messages received by a base station and a possible resource block allocation determined using the reporting messages. In one embodiment, the system 500 may include a base station (not shown) and two MSs 508 and 510. It is understood that the above are merely one illustrative example to which the disclosed subject matter is not limited, and that in various embodiments the number of resource blocks, MSs, reporting messages, etc. may be higher, in some cases much higher. Also, for purposes of simplicity it is assumed that, in this embodiment, the MSs 508 and 510 may only have a single antenna each, or that all of their antennas experience substantially the same SNR for each resource block.

In one embodiment, first MS 508 may transmit two reporting messages 504 and 504a. In one embodiment, the reporting message 504 may make use of or be transmitted via resource block #2 502b. Likewise, the reporting message 504a may make use of or be transmitted via resource block #7 502g.

In one embodiment, second MS 510 may transmit two reporting messages 506 and 506a. In one embodiment, the reporting message 506 may make use of or be transmitted via resource block #4 502d. Likewise, the reporting message 506a may make use of or be transmitted via resource block #7 502g.

In various embodiments, the BS may allocate two resource blocks or two per time period (as time in excess of one RB is not represented in FIG. 5) to the MSs 508 and 510. MS 508 may be allocated resource block #2 50b as its reporting message 504 was transmitted via this resource block. The second MS 510 may be allocated resource block #4 50d as its reporting message 506 was transmitted via this resource block. In such an embodiment, the BS may allocate resource blocks based, in part, upon the quality of SNR experienced and reported by the various MSs.

In another embodiment, the BS may also consider the amount of data to be transmitted between the respective MSs and the BS. In such an embodiment, if there is less need for resource blocks than there are “good” resource blocks, only the number of resource blocks needed may be allocated. Conversely, in one embodiment, if the amount of data to be transmitted (either in DL or UL sub-frames) is greater than number of “good” resource blocks, the BS may only allocate the “good” RBs and postpone data transmission. In another embodiment, faced with the same transmission needs and insufficient “good” resource blocks, may allocate non-“good” resource blocks and effectively take a chance that the data will be correctly received. It is understood that the above are merely a few illustrative example of allocation choices and trade-offs to which the disclosed subject matter is not limited.

In some embodiments, the BS may have difficulty determining which of the two MSs 508 or 510 transmitted the reporting message occurring on or via resource block #7 502g. In such an embodiment, the BS may refrain from allocating resource block #7 502g. In another embodiment, if the transmitting MSs of the co-existing or correlated reporting messages 504a and 506a may be determined, the BS may time multiplex the allocation of the resource block #7 502g. In yet another embodiment, even if the transmitting MSs of the co-existing or correlated reporting messages 504a and 506a may be determined, the BS may refrain from allocating the resource block #7 502g. It is understood that the above are merely a few illustrative example of allocation choices and trade-offs to which the disclosed subject matter is not limited.

FIG. 6 is a table 600 of an example embodiment of a coding scheme of system in accordance with the disclosed subject matter. As described above, a message may be transmitted to and received by each MS or MS antenna that assigns a substantially unique or orthogonal code to each antenna or MS. Table 600 illustrates an example embodiment of a coding scheme that may be used to substantially uniquely identify a plurality (e.g., eight) MSs. In the illustrated example, each MS may include a maximum of two antennas. In various embodiments, the number of MSs, number of antennas, and coding scheme may differ. For example, in one embodiment, a coding scheme may be used that includes substantially unique codes for up to 16 MSs, having a maximum of two antennas each. It is understood that the above are merely a few illustrative examples to which the disclosed subject matter is not limited.

In one embodiment, the table 600 may include a MS column 602 illustrating which MS, of the maximum eight, is assigned the code. It is understood that the codes need not be assigned sequentially or in order. The table 600 may also include the column 604 illustrating the 8-but Walsh code assigned to each MS. It is noted that each MS is assigned a different and uniquely identifiable 8-bit Walsh code. Table 600 may include column 606 that identifies the 4-bit Walsh code assigned to each antennas of the corresponding MS.

In one embodiment, the coding scheme may include a Walsh code. In this context a Walsh code may be used to uniquely define individual antennas or MSs. In various embodiments, Walsh codes may be mathematically orthogonal codes. As such, if two Walsh codes are correlated, the result may be intelligible only if these two codes are the same. As a result, a Walsh-encoded signal may appear, in one embodiment, as random noise to a CDMA capable device, unless that terminal uses the same code as the one used to encode the incoming signal. In various embodiments, such a device may include the base station that assigned the Walsh code.

As described above, in one embodiment, after a BS receives all the MS's reporting messages, the BS may check which MS is reporting its 8-bits of Walsh-code in the different resource blocks. Secondly, in one embodiment, the BS may use the even bits of the 8-bit Wash-code to determine if the MS antenna #1 transmitted a reporting message. In such an embodiment, BS may also use the odd bits of the 8-bit Wash-code to determine if MS antenna #2 transmitted a reporting message. Frequently, all of the antennas of a MS will experience substantially the same SNR. However, occasionally this may not be the case (e.g., a SNR barely equal to the threshold, a broken antenna, etc.).

In one embodiment, because the BS uses the 4-bits of the 8-bit Walsh-code to estimate the channel condition of MS antennas #1 and #2, only 4 pair of even and odd Walsh-codes may be orthogonal to one another. In such an embodiment, it can only be guaranteed that 4 sets of unique codes without channel collision may exist for the MSs with two transmit antennas.

For example, in various embodiments, if first the BS collects the 4 even bits of Wash-codes (i.e., bits #0, 2, 4, and 6) from all the 8-bit Walsh-codes, and the BS collects the 4 odd bits of the Wash-codes (i.e., bits #1, 3, 5, and 7), only the first 4 sets of Walsh-codes may be orthogonal and the second 4 sets of Walsh-codes may be correlated or repeats in some way with the first 4 sets of Walsh-codes. In various embodiments, the Walsh code for each antenna may be interleaved to form a Walsh code for the MS.

Therefore, if one MS transmits its Walsh-code which belongs to the first 4 sets of Walsh-codes and another MS transmits the Walsh-code which belongs to the second 4 sets of Walsh-codes, then these two MSs may not have identifiably unique antenna codes in the same resource band or block at the same time. Therefore, in one embodiment, a code collision or repetition may have a greater than zero probability of occurring. In various embodiments, if two repetitious or correlated Walsh-codes have a collision, then no channel information may be extracted from them.

In various embodiments, the BS may select a SNR threshold value or maximum number of reporting messages, such that, if the active MSs are not close to the maximum capacity of users (e.g., 8 MSs), the probability of a code collision probability may be very low. Conversely, in some embodiments, if multiple MSs have the same correlated resource block (e.g., resource block #7 502g of FIG. 5) and their 4 antenna bits (e.g., even or odd bits) of their respective Walsh-codes are not orthogonal to each other, a BS may transmit an unsolicited code assignment message to assign a new Walsh-code to the user in order to reduce the probability of code collision.

In various embodiments, a resource block may include the capability of transmitting more bits than are necessary or used for the coding scheme (e.g., Walsh code). In such an embodiment, the extra bits may be used for purpose other than identifying the transmitting MS or MS antenna. For example, a resource block may include 18 sub-carriers or bits of information. Such a resource block may, in one embodiment, be used to transmit a 16-bit Walsh code, leaving 2 bits unused. In various embodiments, these unused bits may be positioned at the ends of the resource block to provide a buffer region for noise and inter-resource block interference. In another embodiment, the two bits may be assigned a special purpose or convey information not previously discussed. In yet another embodiment, the bits may be used to identify the antennas of the MS and an even/odd scheme as described above may not be used. Although, it is understood that the above are merely a few illustrative examples to which the disclosed subject matter is not limited.

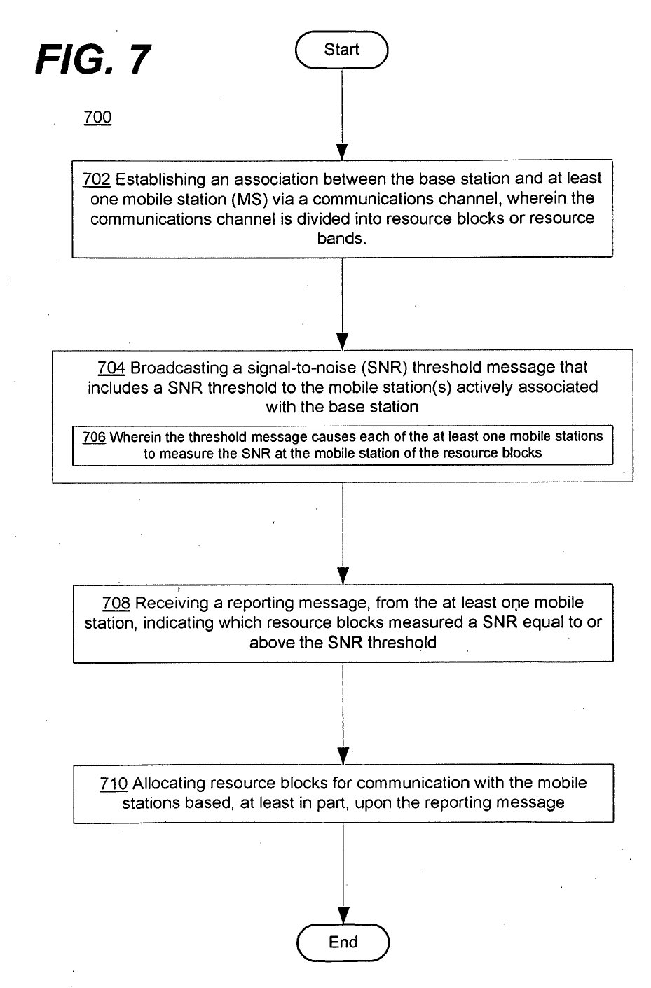

FIG. 7 is a flow chart of an example embodiment of a technique 700 in accordance with the disclosed subject matter. In various embodiments, the technique 700 may be used or generated by an apparatus or system as shown and illustrated by FIG. 1, 2, or 4, as described above.

Block 702 illustrates that, in one embodiment, an association between the base station and at least one mobile station (MS) may be established via a communications channel, wherein the communications channel is divided into resource blocks or resource bands, as described above. In various embodiments, establishing may include assigning a substantially uniquely identifiable code (e.g., a Walsh code) to each antenna of the mobile stations, as described above. In one embodiment, this action may occur separately, as described above. In various embodiments, the action(s) described above may be performed by a base station (e.g., base station 104 of FIG. 1) or a transceiver (e.g., transceiver 202 of FIG. 2), as described above.

Block 704 illustrates that, in one embodiment, a signal-to-noise (SNR) threshold message may be broadcast that includes a SNR threshold to the mobile station(s) actively associated with the base station, as described above. In one embodiment, broadcasting may include broadcasting a mid-amble message that includes a SNR threshold value, as described above. In one embodiment, broadcasting may include In one embodiment, broadcasting may include accumulating data on the condition of the communications channel; and, when the condition of the communications channel falls below a predetermined threshold, broadcasting the SNR threshold message, as described above. In various embodiments, the action(s) described above may be performed by a base station (e.g., base station 104 of FIG. 1), a transceiver (e.g., transceiver 202 of FIG. 2), or a controller (controller 204 of FIG. 2) as described above.

Block 706 illustrates that, in various embodiments, the threshold message may cause each of the at least one mobile stations to measure the SNR at the mobile station of the resource blocks, as described above. In some embodiments, wherein a mobile station includes a plurality of antennas, the threshold message may cause the mobile station to measure the SNR of the resource blocks for each antenna of the mobile station, as described above. In various embodiments, the action(s) described above may be performed by a mobile station (e.g., mobile station 106 of FIG. 1), a transceiver (e.g., transceiver 202 of FIG. 2), or a controller (controller 204 of FIG. 2) as described above.

Block 708 illustrates that, in one embodiment, a reporting message may be received, from the at least one mobile station, indicating which resource blocks measured a SNR equal to or above the SNR threshold, as described above. In one embodiment, receiving may include receiving a message encoded such that each of the at least one mobile stations is substantially identifiably unique, as described above. In one embodiment, receiving may include receiving the reporting message from a mobile station only if the mobile station includes at least one resource block with a SNR equal to or above the SNR threshold value, as described above. In one embodiment, receiving may include receiving a reporting message that includes an interleaved Walsh code, as described above. In one embodiment, receiving may include receiving a reporting message, via the resource blocks measured to have a SNR equal to or above the SNR threshold by the measuring mobile station, that indentifies the measuring mobile station, as described above. In various embodiments, the action(s) described above may be performed by a base station (e.g., base station 104 of FIG. 1) or a transceiver (e.g., transceiver 202 of FIG. 2), as described above.

Block 710 illustrates that, in one embodiment, allocating resource blocks for communication with the mobile stations based, at least in part, upon the reporting message, as described above. In one embodiment, allocating or receiving a reporting message may include determining from which mobile station each reporting message was transmitted, as described above. In one embodiment, allocating or receiving a reporting message may include, if the transmitting mobile station cannot be determined, treating the resource blocks indicated in the reporting message as being below the SNR threshold, as described above. In various embodiments, the action(s) described above may be performed by a base station (e.g., base station 104 of FIG. 1), a transceiver (e.g., transceiver 202 of FIG. 2), or a controller (controller 204 of FIG. 2) as described above.

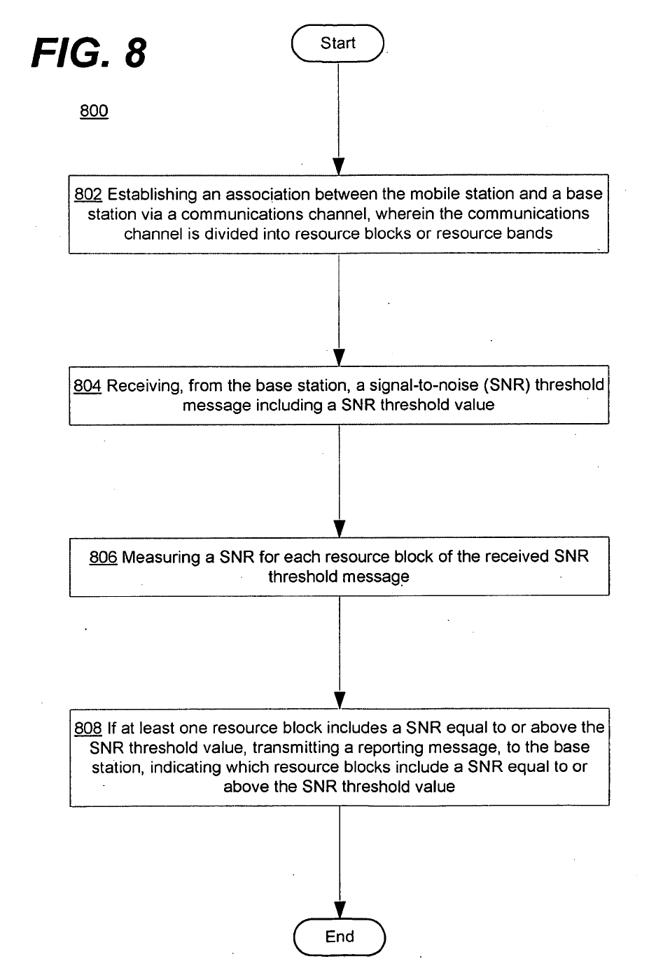

FIG. 8 is a flow chart of an example embodiment of a technique 800 in accordance with the disclosed subject matter. In various embodiments, the technique 800 may be used or generated by an apparatus or system as shown and illustrated by FIG. 1, 2, or 4, as described above.

Block 802 illustrates that, in one embodiment, an association between the mobile station and a base station may be established via a communications channel, wherein the communications channel is divided into resource blocks or resource bands, as described above. In various embodiments, establishing may include being assigned a substantially unique or orthogonal identifier code, as described above. In other embodiments, this code may be assigned outside of the establishment procedure, as described above. In various embodiments, the action(s) described above may be performed by a mobile station (e.g., mobile station 106 of FIG. 1), a transceiver (e.g., transceiver 202 of FIG. 2), or a controller (controller 204 of FIG. 2) as described above.

Block 804 illustrates that, in one embodiment, a signal-to-noise (SNR) threshold message may be received, from the base station, wherein the message includes a SNR threshold value, as described above. In various embodiments, the action(s) described above may be performed by a mobile station (e.g., mobile station 106 of FIG. 1), or a transceiver (e.g., transceiver 202 of FIG. 2) as described above.

Block 806 illustrates that, in one embodiment, a SNR for each resource block or resource band of the received SNR threshold message may be measured, as described above. In various embodiments, measuring may include measuring a SNR for each resource block or resource band for each antenna, as described above. In various embodiments, the action(s) described above may be performed by a mobile station (e.g., mobile station 106 of FIG. 1), a transceiver (e.g., transceiver 202 of FIG. 2), or a controller (controller 204 of FIG. 2) as described above.

Block 808 illustrates that, in one embodiment, if at least one resource block includes a SNR equal to or above the SNR threshold value, a reporting message may be transmitted, to the base station, indicating which resource blocks include a SNR equal to or above the SNR threshold value, as described above. In one embodiment, transmitting may include interleaving the substantially unique identifier code for each antenna to form the reporting message, as described above. In various embodiments, transmitting may include transmitting the reporting message via only the resource blocks or resource bands that include a SNR equal to or above the SNR threshold value, as described above. In various embodiments, the action(s) described above may be performed by a mobile station (e.g., mobile station 106 of FIG. 1), or a transceiver (e.g., transceiver 202 of FIG. 2) as described above.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A method of using a base station (BS) comprising:
establishing an association between the base station and at least one mobile station (MS) via a communications channel, wherein the communications channel is divided into resource blocks;
broadcasting a signal-to-noise (SNR) threshold message that includes a SNR threshold;
receiving at least one reporting message, respectively from the at least one mobile station(s), indicating which resource blocks measured a SNR equal to or above the SNR threshold; and
allocating, in a time division multiplexing mode, resource blocks for communication with the mobile station(s) based, at least in part, upon the reporting message(s).

2. The method of claim 1 wherein receiving includes:
receiving a signal via an uplink (UL) resource band.

3. The method of claim 1 wherein the reporting message includes:
a Code Division Multiple Access (CDMA) encoded signal representing a substantially orthogonal identifier.

4. The method of claim 1 wherein broadcasting includes:
broadcasting a message via a base station broadcast channel.

5. The method of claim 1 wherein a mobile station includes a plurality of antennas; and
wherein the threshold message causes the mobile station to measure the SNR of the resource blocks of the communications channel for each antenna of the mobile station and compare with the broadcasting SNR threshold;

6. The method of claim 1 wherein receiving includes receiving a message encoded such that each of the at least one mobile stations is identifiable via a substantially unique orthogonal code.

7. The method of claim 1 wherein receiving includes:
receiving the reporting message from a transmitting mobile station only if the transmitting mobile station measured at least one resource block with a SNR equal to or above the SNR threshold value.

8. The method of claim 7 wherein receiving includes:
if the transmitting mobile station measured more than a set maximum number of resource blocks with a SNR equal to or above the SNR threshold value, receiving a reporting message from the transmitting mobile station including only the set maximum limit of resource blocks with the highest SNR.

9. The method of claim 1 wherein receiving includes:
receiving a reporting message that includes an interleaved orthogonal code sequence.

10. The method of claim 1 wherein receiving includes:
receiving a reporting message, via the resource blocks measured by a measuring mobile station to have a SNR equal to or above the SNR threshold by the measuring mobile station, that indentifies the measuring mobile station.

11. The method of claim 1 further including:
assigning a Walsh code to each antenna of each associated mobile station.

12. The method of claim 1 wherein receiving includes:
determining from which mobile station each reporting message was transmitted; and
if the transmitting mobile station cannot be determined, treating the resource blocks indicated in the reporting message as being below the SNR threshold.

13. A method of using a mobile station comprising:
establishing an association between the mobile station and a base station via a communications channel, wherein the communications channel is divided into resource blocks;
receiving, from the base station, a broadcast signal-to-noise (SNR) threshold message including a SNR threshold value;
measuring a SNR for each resource block of the received SNR threshold message; and
if at least one resource block includes a SNR equal to or above the SNR threshold value, transmitting a reporting message, to the base station, indicating which resource block(s) include a SNR equal to or above the SNR threshold value.

14. The method of claim 13 wherein transmitting includes:
transmitting the reporting message via only the resource blocks that include a SNR equal to or above the SNR threshold value.

15. The method of claim 13 wherein the mobile station includes at least one antenna configured to communicate with the base station; and
wherein transmitting includes transmitting a substantially orthogonal identifier code for each antenna.

16. The method of claim 15 wherein measuring includes:
measuring a SNR for each resource block for each antenna.

17. The method of claim 15 wherein transmitting includes:
interleaving the substantially orthogonal codes for the antennas to form the reporting message.

18. An apparatus comprising:
a transceiver configured to:
establish an association between the apparatus and at least one mobile station (MS) via a communications channel, wherein the communications channel is divided into resource bands,
broadcast a signal-to-noise (SNR) threshold message that includes a SNR threshold, and
receive at least one reporting message, from at least one of the mobile stations, indicating which resource bands the respective mobile station(s) measured a SNR equal to or above the SNR threshold;
a memory configured to:
store at least a portion of the information included in the received reporting message(s); and
a controller configured to:
allocate resource blocks for communication with the mobile station(s) based, at least in part, upon the received reporting message(s).

19. The apparatus of claim 18 wherein controller is configured to:
assign an orthogonal code to each associated mobile station.

20. The apparatus of claim 18 wherein the controller is configured to:
determine, by resource band, which mobile station transmitted each received reporting message; and
allocated resource blocks associated with resource bands based, in part, upon the mobile station that transmitted a reporting message associated with the respective resource band.

21. An apparatus comprising:
a transceiver configured to:
establish an association between the apparatus and a base station (BS) via a communications channel, wherein the communications channel is divided into resource bands,
receive, from the base station, a signal-to-noise (SNR) threshold message including a SNR threshold value;
if at least one resource band includes a SNR equal to or above the SNR threshold value, transmit a reporting message, to the base station, indicating which resource bands include a SNR equal to or above the SNR threshold value; and
a controller configured to:
measure channel state information for each resource band of the communications channel.

22. The apparatus of claim 21 wherein the transceiver is configured to:
transmit the reporting message via only the resource band(s) that include a SNR equal to or above the SNR threshold value.

23. The apparatus of claim 21 wherein the transceiver is configured to:
receive a code assignment message that includes a code sequence including a substantially orthogonal identification code; and
transmit a reporting message including the received substantially orthogonal identification code.

24. The apparatus of claim 21 wherein the transceiver includes a plurality of antennas; and
wherein the controller is configured to:
measure, for each antenna, channel state information for each resource band of the received SNR threshold message; and
wherein the transceiver is configured to:
transmit a reporting message that further indicates, for each resource band, which of the plurality of antennas measured a SNR above the SNR threshold value.

25. The apparatus of claim 21 wherein the transceiver includes a first antenna and a second antenna; and
wherein the transceiver is configured to:
transmit a reporting message that includes a Walsh code having a first number (2N) of bits,
wherein the Walsh code includes:
a first portion representing the first antenna, occupying the even bits of the reporting message, and having a Walsh code including one half of the first number (N) bits, and
a second portion representing the second antenna, occupying the odd bits of the reporting message, and having a Walsh code including a one half of the first number (N) bits.
